(19) United States
(12) Patent Application Publication
(10) Pub. No.: US 2022/0196363 A1
(43) Pub. Date: Jun. 23, 2022

(54) SYSTEM FOR IMPROVING ARCHER SHOOTING MECHANICS AND TECHNIQUE

(71) Applicants: Austin Allgaier, Oswego, IL (US); Justin Rogness, Plainfield, IL (US); Derek Stewart, Clearfield, UT (US)

(72) Inventors: Austin Allgaier, Oswego, IL (US); Justin Rogness, Plainfield, IL (US); Derek Stewart, Clearfield, UT (US)

(21) Appl. No.: 17/551,637

(22) Filed: Dec. 15, 2021

Related U.S. Application Data
(60) Provisional application No. 63/126,888, filed on Dec. 17, 2020.

(51) Int. Cl. F41B 5/14; G01P 1/00

(52) U.S. Cl. CPC F41B 5/1476; G01P 15/18; G01P 1/06; F41B 5/1484

(57) ABSTRACT

An archery bow facility for launching an arrow includes a flexible bow and a bow string connected to the bow. A sensor connected to the bow is operable to generate a datastream based on a condition of the bow. A processor and display in communication with the sensor is operable to receive the datastream and to determine a first bow position at a moment of initiation of release when the bowstring is released by a user. The processor, based on the datastream, then operates to determine a second bow position at a moment of conclusion of release when the arrow departs the bowstring. The processor may operate in conjunction with the display to communicate to a user information about the difference between the first and second positions. The first and second position may be first and second angular orientations, and the sensor is preferably a multi-axis accelerometer.

### CROSS-REFERENCE TO RELATED APPLICATIONS

This application claims the benefit of U.S. Provisional Patent Application No. 63/126,888, filed on 17 Dec. 2020, entitled “SYSTEM FOR IMPROVING ARCHER SHOOTING MECHANICS AND TECHNIQUE”, which is hereby incorporated by reference in its entirety for all that is taught and disclosed therein.

### FIELD OF THE INVENTION

The present invention relates to archery accessories for sensing, recording, analyzing, and displaying spatial displacements of an archery bow during and between one or more arrow shots.

### BACKGROUND AND SUMMARY

Archery is a sport where success is defined by fundamental consistency and stability of the entire shot process. Traditionally, shooters have used the location of where the arrow lands, self-diagnosis, external observation, and slow-motion video capture to determine technique deficiencies and improvements. There are limitations to all of these methods: where the arrow lands is a combination of factors, of which technique is only one; and it is often difficult to self-diagnose while the focus is on something else. Also, there are limits to what the human eye is able detect; and video capture only provides a two-dimensional visual that is inefficient to review and provides no quantitative analysis of the actual process. Superior methods in contrast would include external observation and feedback, again subject to the limits of human capacity.

The above disadvantages are addressed by an archery bow facility for launching an arrow comprising, besides a flexible bow and bow string connected to the bow; a sensor connected to the bow which may be used to generate a datastream based on real-time conditions of the bow. A processor and display in communication with the sensor receives the datastream, and by computation determines among other conditions a first bow position at a moment of initiation of release when the bowstring is released by a user. The processor, based on the datastream then operates to determine a second bow position at a moment of conclusion of release when the arrow departs the bowstring. The processor operates in conjunction with the display to communicate to a user information about the difference between the first and second positions.

### BRIEF DESCRIPTION OF THE DRAWINGS

FIG. 1a shows an archer with a bow and its bowstring drawn in preparation for a shot and including apparatus in accordance with the invention.

FIG. 1b shows an enlargement of a portion of a bow in which a sensor is optionally affixed to the bow near the arrow rest.

FIG. 2a shows a display of a trace of the movement of the bow throughout an entire shot process.

FIG. 2b shows a display of a detailed movement during a particular phase in relation to other shots in the same phase, including displayed measurements of axial movements and velocities over time and during different phases of a shot.

FIG. 3 shows a display of pitch and cant of the bow at the time of release, allowing the user to view consistency and shooting trends.

FIG. 4 shows a display of measured time durations of each phase of several shots, as well as shot splits.

FIG. 5 shows a display of an accumulation of placements of several shots.

FIG. 6 shows a display of an aggregated data visualization, such as by phase, wherein severity and commonality of particular movement patterns are highlit.

FIG. 7 shows a display of identification of technique deficiencies, paired with displayed remedies and corrective actions based on heuristic analysis of the motion data.

FIG. 8 shows a display of historical trends of shooting technique.

### DETAILED DESCRIPTION OF PREFERRED EMBODIMENTS

The overall objectives of archery as a sport, as a hunting skill, or a military skill have been understood for millennia, which include how to use the bow to loose an arrow so that it lands to a distant, targeted point of impact. Building archery skills includes building and finely honing a set of coordinations involving the eye, proprioception, and muscle memory of an archer. The invention is a system which helps archers improve skills, techniques, and the overall form of the process of nocking and arrow, drawing, holding at a draw, aiming, loosing the arrow, and follow through motions which stabilize the arrow rest during the acceleration and departure of an arrow from the bow, so that accuracy at range is achievable and repeatable from one shot to the next. In this specification the words “shooter,” “archer,” and “user” are used interchangeably and with equivalent meanings.

The invention comprises a wireless inertial measurement unit (IMU) that provides real-time feedback on shooting mechanics by analyzing the shooter-induced movements on the bow. An IMU may comprise one or more multi-axis accelerometers, multi-axis gyroscopes, multi-axis magnetometers, or their single-axis variants, or a combination of any of these for monitoring up to 9 axes or 9 degrees of freedom including rotational and linear displacements, as well as the sensor unit incorporating technologies such as piezoelectric materials, laser gyroscopes, and MEMS (micro-electronic mechanical systems.) Movement patterns during different phases of the shot are analyzed and provide quantitative feedback about the quality of the shooter's technique. The invention comprises a 9-axis inertial measurement unit that sends the accelerometer, gyroscope, and magnetometer data wirelessly (such as via Bluetooth, Bluetooth Low Energy, WiFi, or other means) to a computing device (such as a smartphone, tablet, personal computer, or other means) that provides analytics and diagnostics about shooting performance.

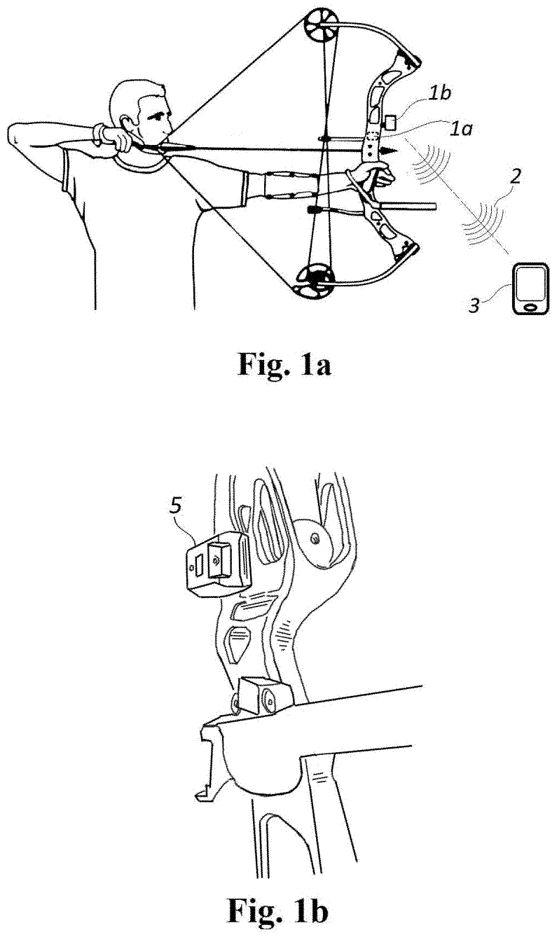

FIG. 1a shows an archer with a bow and its bowstring drawn in preparation for a shot and including apparatus in accordance with the invention. The IMU is mounted anywhere on the bow, such as in locations [1a] or [1b] shown, and collects and analyzes the data. The data is transmitted wirelessly [2] to a computing device [3] such as a smartphone, tablet, or personal computer where visualizations are rendered and quantitative analysis is performed along with coaching tips and statistical analysis.

FIG. 1b shows an enlargement of a portion of a bow in which a sensor [5] is optionally affixed to the bow near the arrow rest. For instance, it may be mounted to a picatinny rail attachment that is taped, strapped, or bolted onto a riser. It is not limited to this configuration, however, as the software is configurable to support any location and orientation. Preferably the sensor package may be mounted to the side of the riser or sight bar in a horizontal configuration as shown in this figure. The sensor acts as a multi-axis accelerometer or rate-sensitive integrating accelerometer for generating samples most preferably at around 400 samples per second or other sampling rates convenient for the purposes of gathering, calculating, and displaying linear and angular accelerations which may be mathematically integrated by a computer processor to produce velocity and displacement data. For example, a sampling rate between 10 and 1000 samples per second would be suitable for operation of the invention. Where a piezoelectric material is used as an accelerometer, a capacitive element may be included as an analog integrator to act as a rate-sensitive displacement transducer. Rate data received by the computing device may then be mathematically integrated by computer to produce displacement data. Thus, for the archery bow facility as described herein, the processor is operable to mathematically integrate acceleration data and compute both linear displacement data and angular displacement data.

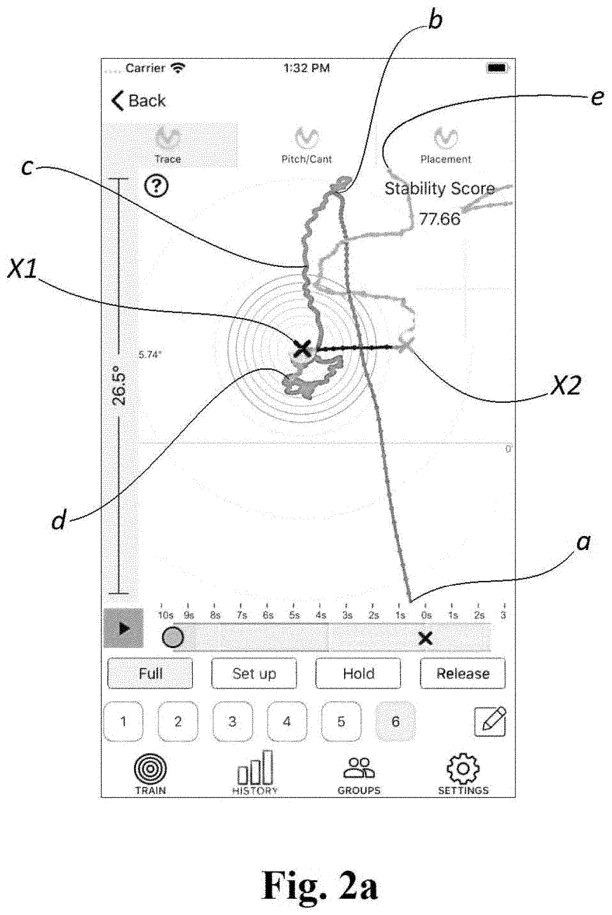

FIG. 2a shows a display of a trace of the movement of the bow throughout an entire shot process. Each phase of the entire shot process is timed, i.e, the duration of each phase is measured and transmitted to and stored in a non-transitory computer-readable medium which acts as a data storage and retrieval system. The “X” symbols indicate key events in the shot process: [X1] is when the arrow is released, and [X2] is when the arrow leaves the bow. Various scores are provided for quantitative analysis, including a stability score which is computed by measuring the magnitude of movement during the hold period of the shot, a consistency score measuring the similarity of traces accumulated from a plurality of shots, such as by computing statistical regression analyses, a smoothness score which may be computed by measuring the magnitude of in-process micro-movements or by analyzing differential functions computed from linear or angular velocity or acceleration measurements and then awarding high scores for constant values of first, second, or higher order differential equations deduced by computational analysis of the aggregated data. Comparison scores may also be computed by measuring key components or portions of a shot sequence in comparison to a benchmark, a standard, a stored preference such as a target value, or a “record” value previously achieved. Smoothness and consistency may also be computed and displayed for a follow-through score which is the motion of the bow after release of an arrow and during acceleration of the arrow while it is still being guided by contact with the arrow rest or other portions or components of the bow.

The sensor connected to the bow generates a datastream based on real-time conditions of the bow. The processor in communication with the sensor receives the datastream, and by computation determines instantaneous positions, velocities, and accelerations, including among other conditions a first bow position at a moment of initiation of release when the bowstring is released by a user. The processor, based on the datastream, then operates to determine a second bow position at a moment of conclusion of release when the arrow departs the bowstring. The processor operates in conjunction with the display to communicate to a user information about the difference between the first and second positions. The datastream may comprise data in the form of Cartesian or polar coordinate data and may be logged and plotted as ordinate and abscissa values associated with each temporal value generated by the sensor. The first and second positions may also be computed and logged as first and second angular orientations.

In the trace of the exemplary shot shown in this figure, data recording and analysis begins at point [a,] and the trace segment from [a] to [b] represents raising of a drawn bow. The segment from [b] to [c] represents aiming the drawn bow, and the segment from [c] to [X1] represents holding on target while the archer is stabilizing breathing, draw force, and “anchor points” which are certain contact points of a part of the bow system such as a portion of the string or the nock of the arrow with a point on the archer's body which is especially sensitive and memorable to tactile sensation, by which the archer endeavors to establish repeatability and exactitude from one shot to the next.

A first portion of the segment from [c] to [d] is an initial or gross approximation of holding on the target and is followed by a second, more exacting refinement of the archer holding at aim from [d] until the decision to loose the arrow is made at [X1.] During this period, the processor is operable to determine a first duration of a hold interval prior to the moment of initiation of release. At release, acceleration of the arrow proceeds from [X1] to [X2] as stored mechanical energy is transferred from the bow to the arrow through the bowstring, and during this time any lateral or vertical excursions at the arrow nock or arrow rest will tend to detract from arrow accuracy by inducing an initial “wobble” of the arrow which attenuates in flight at the expense of some additional drag. During this phase the processor is operable to determine a second duration of a launch interval after the moment of initiation of release and before the moment of its conclusion. Superior technique and improvement in accuracy may be achieved by an archer studying this portion of the trace and endeavoring to stabilize arm and upper body musculature during the release phase.

The remaining portion of the trace from [X2] to [e] is the “follow through” phase which, as in many other precision striking or launching activities such as blacksmithing, carving by chisel, hitting a baseball or golf ball, or throwing a spear, steadiness of form in the follow-through abets smoothness and steadiness at the end of the preceding phase which is often crucial to the accuracy and consistency of the act. During the period after the arrow has lost contact with the bow and enters free flight, the processor is operable to determine a third duration of a launch interval after the moment of conclusion of the bow accelerating the arrow. The processor is also operable to determine a fourth duration of a launch interval being a transition between hold and launch, and also to determine a fifth duration of a launch interval being a transient between launch and follow through.

FIG. 2b shows a display of a detailed movement during a particular phase, in relation to other shots in the same phase, including displayed measurements of axial movements and velocities over time and during different phases of a shot. In this figure the user has selected a “Hold” display function examining an end portion of the [c] to [d] phase and the [d] to [X1] phase seen in the previous figure. The application has accumulated motion data from several shots which are listed by rounded square “buttons” “1” through “6” near the bottom edge of the display, and of which number “6” is currently selected. The selected trace is displayed brightly and to the fore of the set of shot traces. In this specification, the words “button,” “tab,” and “switch” refer to illuminated or demarcated zones on a touch screen which activate or execute software functions when contacted by human skin or a stylus. In this example the “Trace” tab has been selected from among the functional tabs along the top of the display.

Non-selected traces [8] appear dimmed and behind the selected trace. The end portion of the initial phase of the hold follows trace portions [a,] [b,] and [c,] then looping around itself at [d] to a lateral excursion [e.] The archer then appears to overcorrect, swinging sharply through along [f] and looping back from the overshoot of [g] to droop a little at [h.] After a second correction [k] the archer settles into the second, steadier phase of the hold illustrated by region [m] where the points superimpose over each other to form a blob of points as the target [X] is approached smoothly and with determination.

Two trace signatures for vertical excursion [9a] and horizontal excursion [9b] are displayed for analysis by the shooter. The first displayed portion of the hold proceeds from the left ends of the traces to about the 3.75 second mark, and the second, smoother and more precisely controlled portion of the hold proceeds thereafter to the right ends of the trace. Below these traces are displayed four functional buttons by which the shooter may display the “Full” event, or the “Set up,” “Hold,” or “Release” portions of the shot. For this illustration, the “Hold” function is selected.

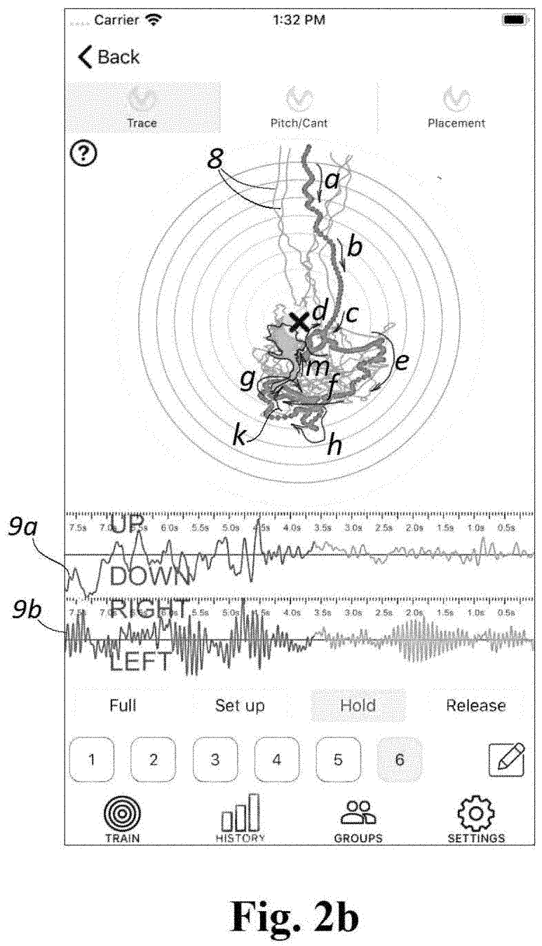

FIG. 3 shows a display of pitch [P] and cant [C] of the bow at the moment of release, allowing the user to view consistency and shooting trends. In this example the “Pitch/Cant” tab has been selected from among the functional tabs along the top of the display. For each release an instructive graphic [12] is constructed and displayed which comprises a lighter or thinner set of a first vertical reference line [13a] and a second horizontal reference line [13b] and a third distinctive or heavier bow line [14] overlain atop the intersection of the two reference lines. Pitch is displayed plotting the instructive graphic as a vertical distance relative to a zero point on a vertical pitch scale [10] displayed to the side of the set of instructive graphics. Cant is an angle of a plane defined by the bow and its drawn bowstring relative to a vertical reference plane, and in this invention cant is displayed graphically by the angle of the bow with respect to the vertical reference of the instructive graphic, and the cant angle is also displayed as a numerical figure proximal to the bow line and also with the bow line displayed at the cant angle with respect to the first vertical reference line. It is also possible to configure the software to display pitch and cant at other selected moments during a completed shot sequence, and the invention will operate equally well for left-handed or right-handed shooters.

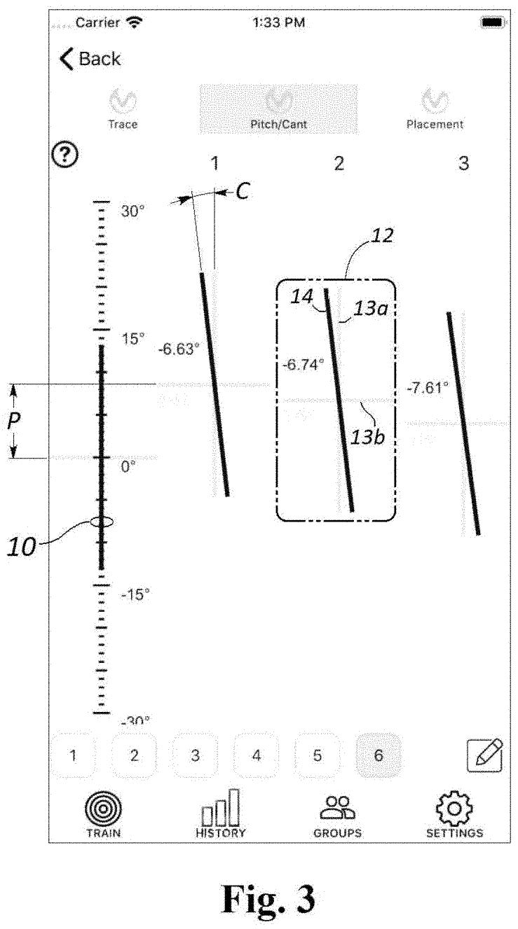

FIG. 4 shows a display of measured time durations of each phase of several shots, as well as shot splits. A “split” is an interval of time between the release of one shot and the next, and in military archery it would be a desirable quality analogous to a rate of fire achievable with a repeating or automatic firearm. In bow hunting, shorter split times would enable a hunter engaging a herd of animals to make more shots and take down more animals in time before the herd flees or disperses. In this example the “Timer” tab has been selected from among the functional tabs along the top of the display. A user may thus cycle through a database compiled of several shots to review individual shots and also statistical averages and analyses. Consistency of form may be analyzed, and outliers may be quickly identified and isolated. One very beneficial utility provided by the invention is that the effects of psychological flinching may be discovered and corrected. The abrupt change in forces sensed within an archer's muscles and the sounds emitted by an accelerating bowstring are unique and unnatural to the human experience. Also, prior mistakes leading to discomfort or injury (such as an accelerating bowstring striking an archer's chest or inner forearm) may have imprinted negative experiences during early learning such that the release of an arrow is accompanied by fear, nervousness, or a momentary sense of revulsion. These negative factors create flinch, which by means of the invention may be detected and addressed by practice.

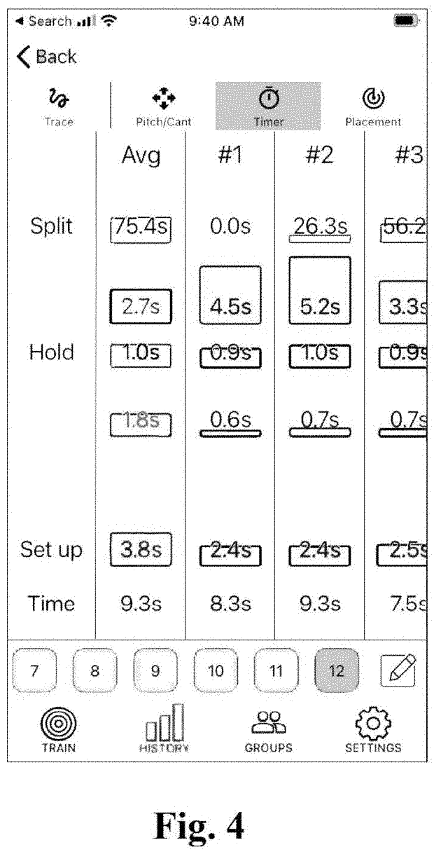

FIG. 5 shows a display of an accumulation of placements of several shots. In this example the “Placement” tab has been selected from among the functional tabs along the top of the display. With this function active, a user manually enters the impact points so that the software application may then map the paper result of each shot to its trace. In this example, the first shot (#1) scored in the “9” ring on the target. A cursor [15] in this example comprises two highly visible concentric circles for aiding the user in plotting the impact location of each shot.

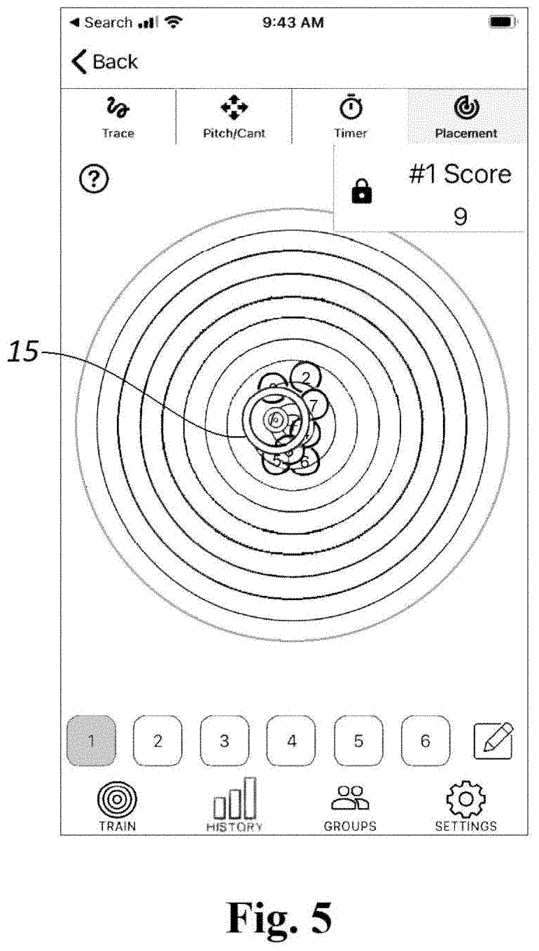

FIG. 6 shows a display of an aggregated data visualization, such as by phase, wherein severity and commonality of particular movement patterns are highlit by means of displayed segments. In this example, the radial location of a displayed segment relative to a vertical “top” or “12 o'clock” reference may relate to an angular direction of deviation of a shot impact point from the target center. The angular width of the displayed segment may relate to a hold time or optionally a shot split time from a previous shot to the current shot, and the radial extent of the displayed segment may relate to radial distance of a shot impact point from the target center. In this example, segment [s₁] resides approximately at an 8-o'clock position and displays as a narrow angular width indicating that in that particular shot the archer was able to settle into an effective hold in less time than the other shots. Another shot indicated by segment [s₂] strayed in approximately a 3-o'clock direction from target center, but the archer took longer during the hold than [s₁.] Three other shots displayed by segment [s₃] strayed in approximately a 5-o'clock direction from target center, and the archer had similar hold times for these three shots, so they are displayed superimposed. The three radii [r₁,] [s₂,] and [r₃] depict the radial distances of these three shots from target center. In other embodiments within the scope of the invention, the software may be configured to depict other shot parameters as angular widths and radial locations and extensions of the displayed segments, and different segments may be displayed in different colors to increase the contrast of data in close proximity to each other or to display along a color spectrum, a color gradient, a hue gradient, a brightness gradient, or a color saturation gradient so as to illustrate the magnitudes or relative values of the set of shots with respect to an additional measured, computed, or statistically aggregated parameter.

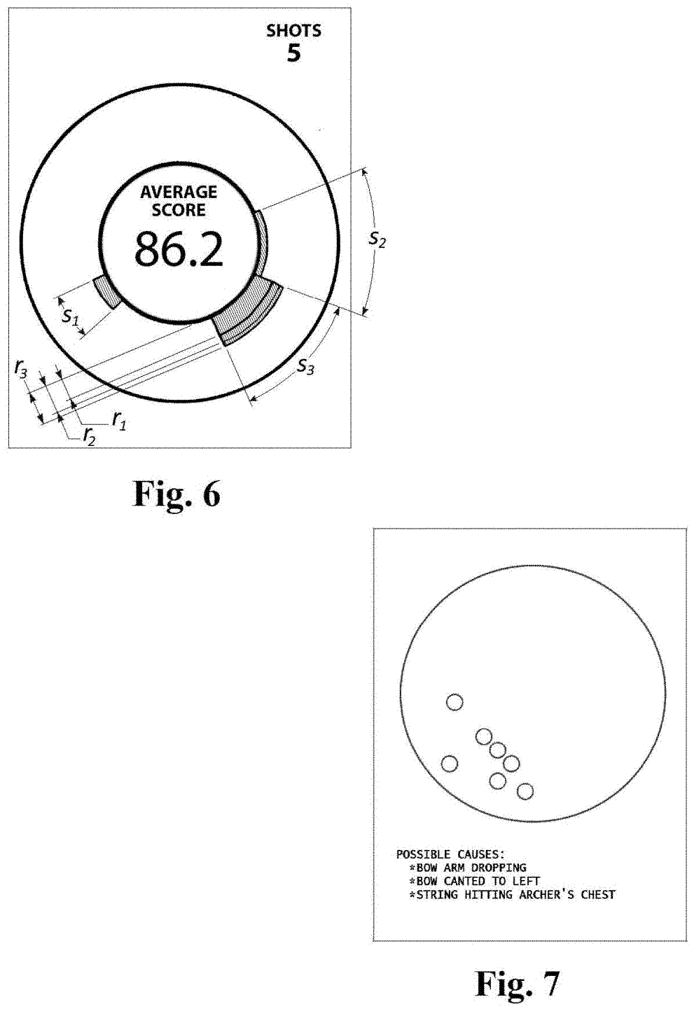

FIG. 7 shows a display of identification of technique deficiencies, paired with displayed remedies and corrective actions based on heuristic analysis of the motion data. In this display a plurality of shot impact points are displayed from the mapped impact points entered by the user according to the description of FIG. 5. In the exemplary display shown, a set of shots evince an aggregate deviation from the target center. Deviations along particular radial directions are often diagnostic of particular deficiencies of archery shooting form and practice, and the software computes and correlates direction of the deviancy and then selects cause elements from one or more sets or lists of various known causes typically associated with particular deviant directions from target center. These cause elements are then displayed proximal to the shot group as a diagnostic critique of the shooter's form, which allows the shooter to concentrate on reforming deficiencies by trying new corrective techniques in future shots. The results of these shots may evince certain improvements and mitigation of the listed deficiencies, allowing the shooter to retain these improvements.

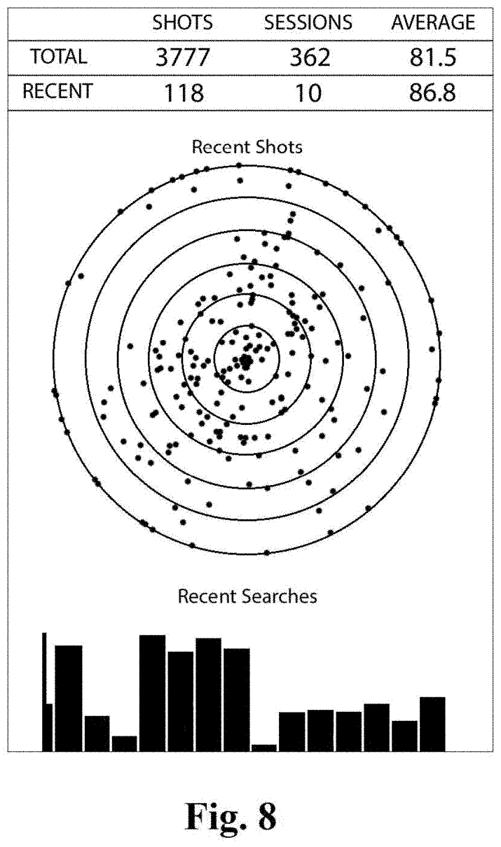

FIG. 8 shows a display of historical trends of shooting technique. Aggregate data collected from many shooting events such as practice days, competitions, and hunting trips may be overlain for comparison and analysis by the shooter. By displaying a subset of recent data in comparison with the entire stored database of shots from the beginning of the use of the invention or from a last complete purge of collected data further in the past to the present, the difference between computed performance parameters over the entire range of collected data and the performance parameters calculated using only the subset of recent activity will evince the shooter's performance trends, including long-term improvements in form, or new emerging aspects of concern, such as the unintended accrual of a bad habit, or performance loss due to fatigue or even decline of a shooter's health or other physical faculties.

Lastly, many of the figures include other display elements not specific to the invention, such as symbolic displays of signal strength or signal integrity of the wireless connection between the sensor and the computing and display device, current day, date and time, battery charge level in the computing device, and other modes such as device or software settings, and the ability to share and compare data within social networks. Thus it should be appreciated that the present disclosure is to be understood to be limited only by the terms of the appended claims, along with the full scope of equivalents to which such claims are entitled.

I claim:

1. An archery bow facility for launching an arrow, the facility comprising;
a flexible bow;
a bow string connected to the bow;
a sensor connected to the bow and operable to generate a datastream based on a condition of the bow;
a processor and display in communication with the sensor;
the processor operable to receive the datastream, and to determine a first bow position at a moment of initiation of release when the bowstring is released by a user;
the processor based on the datastream being operable to determine a second bow position at a moment of conclusion of release when the arrow departs the bowstring;
the processor being operable in conjunction with the display to communicate to a user information about the difference between the first and second positions.

2. The archery bow facility of claim 1, wherein the first and second position are first and second angular orientations.

3. The archery bow facility of claim 1, wherein the sensor comprises an inertial measurement unit.

4. The archery bow facility of claim 1, wherein the processor is operable to determine a first duration of a hold interval prior to the moment of initiation of release.

5. The archery bow facility of claim 1, wherein the processor is operable to determine a second duration of a launch interval after the moment of initiation of release and before the moment of conclusion.

6. The archery bow facility of claim 1, wherein the processor is operable to determine a third duration of a launch interval after the moment of conclusion.

7. The archery bow facility of claim 1, wherein the processor is operable to determine a fourth duration of a launch interval being a transition between hold and launch.

8. The archery bow facility of claim 1, wherein the processor is operable to determine a fifth duration of a launch interval being a transition between launch and follow through.

9. The archery bow facility of claim 3, wherein the inertial measurement unit is a wireless inertial measurement unit.

10. The archery bow facility of claim 3, wherein the inertial measurement unit comprises a multi-axis accelerometer.

11. The archery bow facility of claim 3, wherein the inertial measurement unit comprises a multi-axis gyroscope.

12. The archery bow facility of claim 3, wherein the inertial measurement unit comprises a single-axis accelerometer.

13. The archery bow facility of claim 3, wherein the inertial measurement unit comprises a single-axis gyroscope.

14. The archery bow facility of claim 3, wherein the inertial measurement unit comprises a magnetometer.

15. The archery bow facility of claim 3, wherein the inertial measurement unit comprises a piezoelectric material.

16. The archery bow facility of claim 3, wherein the processor is operable to mathematically integrate acceleration data to compute linear displacement data.

17. The archery bow facility of claim 3, wherein the processor is operable to mathematically integrate acceleration data to compute angular displacement data.

18. The archery bow facility of claim 1, wherein the processor is operable to display
a vertical pitch scale including a zero point and
an instructive graphic comprising a first vertical reference line, a second horizontal reference line, and a third bow line overlain atop an intersection of the first vertical reference line and second horizontal reference line, and
wherein a cant angle is displayed as an angle between the bow line and the first vertical reference line, and
wherein a pitch angle is displayed as a vertical distance relative to the zero point of the vertical pitch scale.
